(19) United States
(12) Patent Application Publication
(10) Pub. No.: US 2008/0120174 A1
(43) Pub. Date: May 22, 2008

(54) METHOD AND SYSTEM FOR FLEXIBLE PRODUCT AND SERVICE BUNDLING

(75) Inventor: Shunge Li, Duluth, GA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Services Organization Inc., Irving, TX (US)

(21) Appl. No.: 11/560,544

(22) Filed: Nov. 16, 2006

(51) Int. Cl. G06Q 30/00

(52) U.S. Cl. 705/14; 705/26

(57) ABSTRACT

Embodiments of the present disclosure are directed to a method and system for flexible product and service bundling comprising an item presentation module that displays a plurality of items and a bundling module that receives a plurality of user selections based on the plurality of items, forms a custom bundle based on the plurality of user selections, calculates one or more discounts based on the custom bundle, calculates terms and conditions associated for each of the one or more discounts, displays the custom bundle and the one or more calculated discounts for review by the user, and processes the custom bundle based on an acceptance review by the user.

### BACKGROUND INFORMATION

On-line shopping has become extremely popular with consumers. It provides a convenient way for people to purchase a variety of products and services without leaving the home or office. When offering items for sale through a web site, on-line vendors may find it useful to group items for sale together into a predefined package or bundle. For example, a vendor who sells airline tickets may also offer hotel and car rental services as one bundled item. If a customer purchases this bundle, he or she may receive a discount that would otherwise not be provided when each product or service is purchased separately, either from the same vendor or from other businesses. As a result, such a capability may be particularly advantageous for increasing sales and improving customer retention.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts an exemplary illustration of a system architecture for flexible bundling, according to an embodiment of the disclosure.

FIG. 2 depicts an exemplary flowchart for flexible bundling, according to an embodiment of the disclosure.

FIG. 3 depicts an exemplary screenshot of flexible bundling, according to an embodiment of the disclosure.

FIG. 4 depicts an exemplary screenshot of flexible bundling, according to an embodiment of the disclosure.

### DETAILED DESCRIPTION OF EMBODIMENTS

Product and service bundling makes shopping convenient and enjoyable. In addition, product and service bundling provides discount incentives for a customer and therefore increases sales and customer retention. However, fixed product and service bundles are typically outdated and inflexible. For example, it is unlikely (or nearly impossible) for a fixed product and service bundle to meet the needs of each and every customer. Moreover, because a product bundle may undergo comprehensive market research, including competitive analysis, financial analysis, and other forms of research, and several lengthy implementation steps, there is often a substantial time-to-market delay. As a result, it may take several months or longer for a newly-conceived product bundle to be successfully introduced to the market.

A system and process of an exemplary embodiment of the disclosure provides flexible product and service bundling. Flexible product and service bundling may provide customers the ability to pick and choose whatever they want to purchase from a product and/or service catalog and form a custom bundle “on the fly.” In one embodiment, a customer may select from a “Top-10” list of most popular custom bundles, which may be created and maintained by a Flexible Bundling Tool (FBT). In support of flexible product and service bundling, a bundling module may be provided to process and generate various custom bundles. One characteristic of a flexible bundle offering may be discounts provided to customers who accept the custom bundles. In this example, the bundling module may be responsible for calculating the amounts of the one or more discounts along with the terms and conditions associated with each of the discounts.

Thus, a flexible bundling approach provides a customer-driven business solution that brings businesses closer to the customer. Rather than providing bundles defined “for” customers, embodiments of the disclosure may provide bundles that are defined “by” customers.

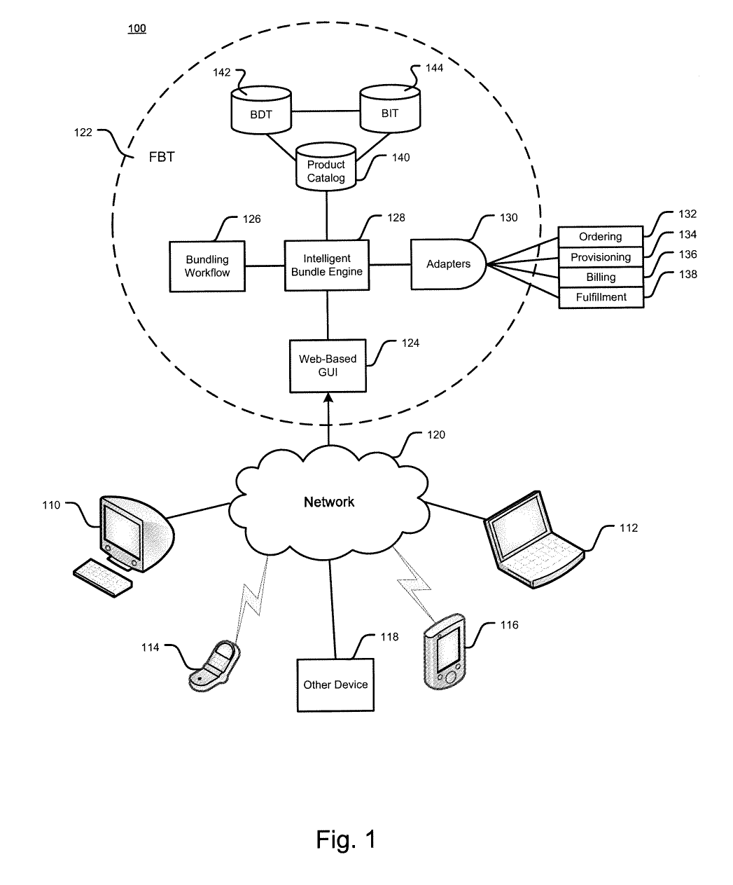

FIG. 1 depicts an exemplary system, according to an embodiment of the disclosure. System 100 may comprise a user interface device from which a user or customer connects to a Flexible Bundling Tool (FBT) 122 via a network 120.

A user interface device may include a computer 110, a laptop/notebook 112, a mobile phone, a personal data assistant (PDA) 116, or other similar device 118. The user interface device may connect to the network 120 in a variety of ways, such as via wired or wireless broadband connection. In one embodiment, wired broadband connection may include long-range optical data communications, local area network based protocols, wide area networks, and/or other similar applications. In another embodiment, wireless broadband connection may include long-range wireless radio, local area wireless network such as 802.11 based protocols, wireless wide area network such as WiMax, and/or other similar applications. Other various embodiments may also be provided. In one embodiment, network 120 may comprise the Internet. Other networks may also be utilized for connecting each of the various systems and/or servers.

Flexible bundling tool (FBT) 122 may include a network-based user interface, such as a Web-Based Graphic User Interface (GUI) 124, from which a user interface device may connect via a network 120. Other various user interfaces may also be used. Flexible bundling tool 122 may also include an Intelligent Bundle Engine 128 that may connect the wed-based GUI 124 with Bundling Workflow 126 and adapters 130. Intelligent bundle engine 128 may also connect to several databases, e.g., a Catalog 140, a Bundle Definition Table (BDT) 142, a Bundle Instance Table 144, or other similar database. Other variations and components may also be provided.

The Intelligent bundle engine 128 may include a workflow engine and at least one bundling module to implement and execute the bundling workflow 126 and to calculate the bundle discounts and the terms and conditions associated with each of the discounts, including information such as when the bundled services will become available, whether the discounts are recurring or non-recurring, when they are applied, the duration of the discount, and other contractual obligations that a customer may have to fulfill in order to receive the discount (e.g., early termination fees). For example, a customer who forms a custom bundle by selecting a mobile phone, a calling plan with a particular service provider, and three add-on calling features may receive an instant, one-time (non-recurring) discount of $100 if he or she agrees to remain with the service provider for at least one year. If the customer terminates his or her service with the provider within one year, he or she may be charged the $100 discount since the condition of the discount has not been met. The intelligent bundle engine 128 may also receive and calculate other various data and/or information associated with bundle customizations.

Bundling workflow 126 may be provided by the flexible bundle tool 122 to specify a set of steps needed to manage the entire bundling process. In one embodiment, this may include querying and creating a bundle in a database, e.g., the Bundle Instance Table (BIT) 144 and/or the Bundle Definition Table (BDT) 142, calculating the bundle discount, generating the terms and conditions for a discount, validating certain constraints and/or dependencies, and invoking system interfaces to get the bundling products and/or services ordered, provisioned, billed, and fulfilled, and applying the bundle discount to the customer's bill or invoice. Other various process steps may also be provided.

Adapters 130 may be provided to the flexible bundling tool (FBT) 122 for communication with various downstream systems, e.g., outside of the flexible bundling tool 122, for performing functions such as ordering 132, provisioning 134, billing 136, fulfillment 138, and other related functions. In one embodiment, adapters 130 may recognize system interfaces, communication protocols, message formats, and data elements in the messages. Other variations may also be provided.

Catalog 140 may include a plurality of items, e.g., a list of a plurality of products, services, and/or popular custom bundles. The catalog database 140 may also include attributes for each product, service, or previously formed custom bundle. For example, each product may also include information such as a price tag, profit margin, which downstream systems interact with for ordering, provisioning, billing, and fulfillment, times required to get the product ordered, provisioned, billed, fulfilled, etc. Constraints or dependencies may also be stored in the catalog database 140. Other data and/or information may also be provided.

Bundle Definition Table (BDT) 142 may store bundle definitions or types. For example, the bundle definition table 142 may specify the products or services that constitute a particular bundle type as well as the systems or applications offering these individual products and constraints or dependencies among these products. Other data and/or information may also be provided.

Bundle Instance Table (BIT) 144 may store bundle instances, associated discounts, terms and conditions, links to customer service records indicating bundle creator information. For example, the bundle instance table 144 may include data and/or information as to when a bundle was created and who created the bundle. This information may be useful for the creator of the bundle for future business or for other customers. In one embodiment, the customer service records may be provided as a separate database that is maintained in ordering 132 and/or billing 134 systems. Other data and/or information may also be provided.

While shown as separate databases, it should be appreciated that the contents of these databases, as depicted in FIG. 1, may be combined into fewer or greater numbers of databases and may be stored on one or more data storage systems. Other data and/or information may also be stored and/or obtained from these databases.

While one configuration is shown in FIG. 1, it should be appreciated by one of ordinary skill in the art that other configurations of these various modules may also be possible. For example, for ubiquitous accessibility, the flexible bundling tool 122 may be implemented as a web-based tool by utilizing a 3-tier architecture. The first tier may represent a user interface tier that includes, for example, the web-based GUI 124. The second tier may include the business logic tier that includes, for example, the bundling workflow 126, the intelligent bundle engine 128, and adapters 130 for communication with downstream systems. The third tier may represent a database tier that includes, for example, a catalog 140, a bundle definition table 142, and a bundle instance table 144, or other similar database. Other various configurations and designs may also be provided.

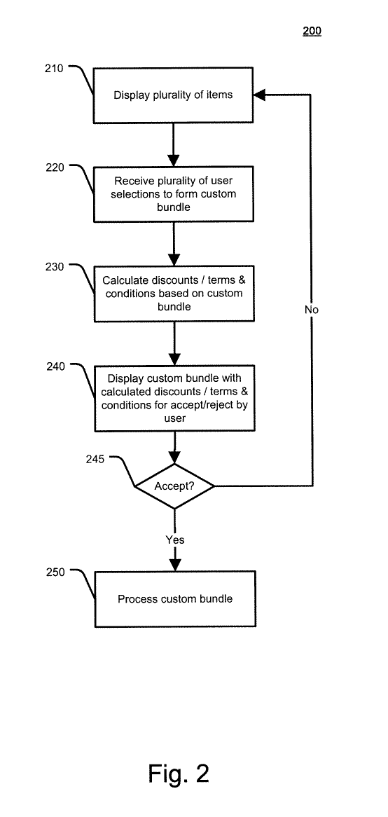

FIG. 2 depicts an exemplary flowchart for flexible bundling, according to an embodiment of the disclosure. In step 210, the flexible bundling tool 122 may display a plurality of items including products, services, and/or most popular custom bundles. In step 220, a plurality of selections made by a user or customer to form a custom bundle may be received. In step 230, one or more discounts and the terms and conditions associated with each of the discounts may be calculated based on the custom bundle formed by the user. In step 240, the flexible bundling tool 122 may display, for the user to review, the custom bundle with the calculated discounts and associated terms and conditions. In this step, the user may decide 245 whether to accept or decline the custom bundle. If the user accepts the custom bundle, the system 100 may proceed to processing the custom bundle, as depicted in step 250. If the user declines the custom bundle, the system 100 may restart the custom bundle creation process, e.g., returning the user to step 210.

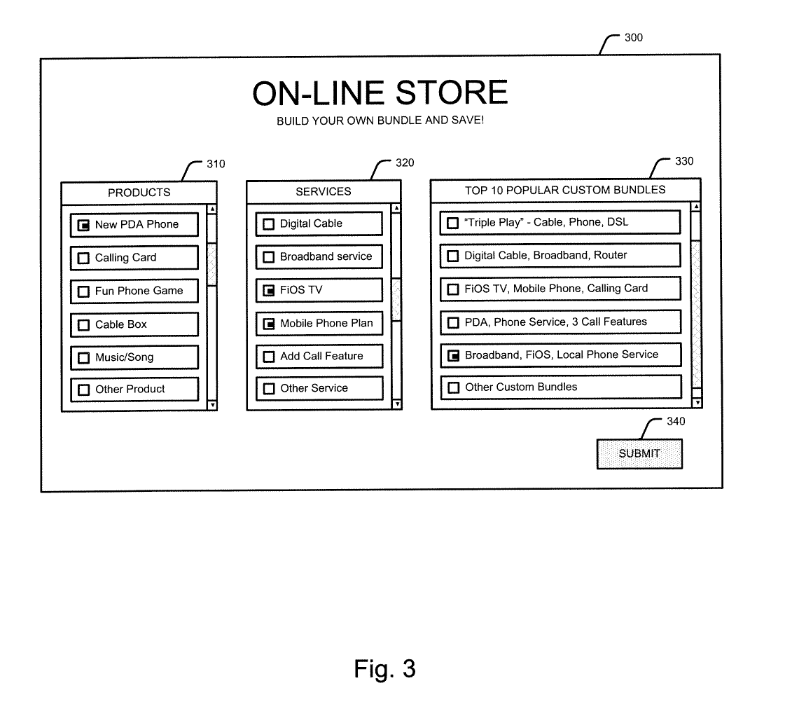

In step 210, a catalog of products, services, and/or most popular custom bundles may be displayed, for example, via an item presentation module. FIG. 3 depicts an exemplary screenshot of flexible bundling according to an embodiment of the disclosure. In this example, the screenshot may provide an on-line store site 300 listing various products 310, services 320, and “Top-10” most popular custom bundles 330. Other various categories may also be provided.

In step 220, a plurality of selections made by a user to form a custom bundle may be received. Referring to FIG. 3, for each of the items presented under the products 310, services 320, and/or popular custom bundles 330, the user or customer may select a plurality of items by clicking a radio button. Other forms of user selection, such as hyperlink, mouseover, input field, text search, etc., may also be provided. The user may also scroll up and down each category to find the items desired to be included in the custom bundle. In one embodiment, the user may deselect an item by clicking a previously selected radio button or other similar deselector. In another embodiment, the customer may deselect or highlighted items by clicking a “clear all” button (not shown). In another embodiment, a detailed description of each item may also be provided via hyperlink, mouseover, or other similar feature at each of the product, services, or popular custom bundle items. Other various embodiments may also be provided.

In step 230, one or more discounts and the terms and conditions associated with each of the discounts may be calculated based on the custom bundle formed by the user. In this example, the intelligent bundle engine 128 calculates the bundle discounts and the terms and conditions associated with each of the discounts. The intelligent bundle engine 128 also calculates information such as when a bundled service will become available, whether a discount is recurring or non-recurring, when the discount is applied, the duration of the discount, and other contractual obligations that a customer may have to fulfill in order to receive the discount (e.g., early termination fees). Other types of data or information may also be calculated.

In one embodiment, to ensure optimal profitability, the intelligent bundle engine 128 may take into consideration the profit margin of each product and/or service in a custom bundle when calculating a discount. This may provide a way to manage the profitability while continuing to provide a certain amount of savings for customers. For example, depending on the profit margins of each of the items in a custom bundle, a discount may be taken from one of the items or all of the items.

In another embodiment, an individual customer's service history may also be used to determine the suggested discounted price. For example, a customer's loyalty and infrequent episodes of complaints may also play a role in determining the discount. Other various information, data, and/or options may also play a role in calculating the discounts and their associated terms and conditions.

In step 240, the custom bundle, calculated discounts, and associated terms and conditions may be displayed for a customer to review. In this step, the user may decide 245 whether to accept or decline the custom bundle.

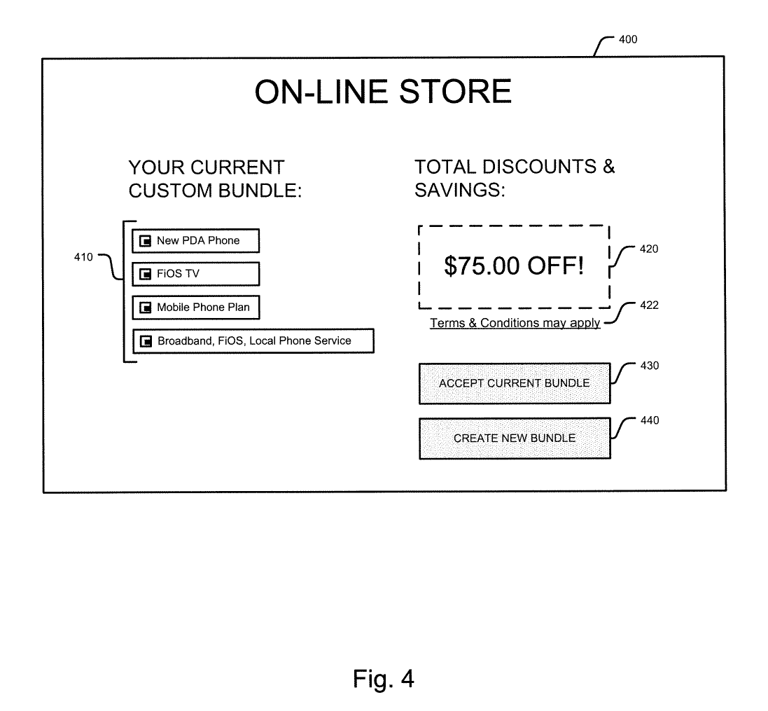

FIG. 4 depicts an exemplary screenshot of flexible bundle according to an embodiment of the disclosure. In this example, the on-line store 400 may display the current custom bundle 410, calculated discounts 420, and associated terms and conditions 422. In one embodiment, displaying the calculated discount may also include the overall discounted final price of the custom bundle. As discussed above, the discount may be applied to one or more items in the custom bundle depending on the profitability of the items in the bundle. Other display options may also be provided. The customer may review his or her options and decide, for example, whether to accept the custom bundle, e.g., by selecting “Accept Current Bundle” 430, or decline and restart the custom bundle creation process, e.g., by selecting “Create New Bundle” 440. In another embodiment, the customer may make additions and/or changes to the custom bundle. Other various embodiments may also be provided.

Once the customer accepts the custom bundle, the bundle may proceed to be processed, as depicted in step 250. In this step, the intelligent bundle engine 128 may coordinate with downstream systems and/or processes via adapters 130 to process additional functions such as ordering 132, provisioning 134, billing 136, fulfillment 138, and other similar functions.

An advantage of flexible bundling, according to an embodiment of the present disclosure, may include significant savings and benefits for customers since bundling is customized and need-based. Flexible bundling may also provide a steadier stream of revenue since customers more easily enter into contractual relationships that may increase sales volume due to discount incentives. In addition, flexible bundling may also achieve optimal profitability. For instance, utilizing a profit-analyzing bundling module may provide an alert notification, for example, that a contract is ready to expire. This may be used by the flexible bundling tool 122 to adjust a custom bundle offering accordingly for improved customer retention. In addition, the bundling feature described above may eliminate the need for costly comprehensive market research and coordination with special implementation teams. The system may also provide customer feedback services that help create, for example, a “Top 10” or most popular custom bundles. By relying on customers' feedback, new product offerings may be provided based on more accurate assessments of customer spending behaviors and shopping trends.

It should be appreciated that while embodiments of the present disclosure are directed to the products and services described above and depicted in the figures, other categories and items may be provided as well.

It should be appreciated that while embodiments of the present disclosure are directed to an on-line store as described above and depicted in the figures, other implementations may be provided as well. For example, flexible bundling may be utilized in on-line auctions and flea markets, television and telephone ordering services, and/or other stores that provide various products and/or services.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A method, comprising:
displaying a plurality of items;
receiving a plurality of user selections from the plurality of items; and
forming a custom bundle based on the plurality of user selections.

2. The method of claim 1, wherein the method further comprises calculating one or more discounts based on the custom bundle.

3. The method of claim 2, wherein calculating the one or more discounts further comprises calculating terms and conditions associated for each of the one or more discounts.

4. The method of claim 2, wherein calculating the one or more discounts further comprises calculating a profit margin for each of the one or more discounts.

5. The method of claim 2, wherein the method further comprises displaying the custom bundle and the one or more calculated discounts for review by the user.

6. The method of claim 1, wherein the plurality of items comprises at least two from a group of products, services, and popular custom bundles.

7. The method of claim 1, wherein the plurality of user selections is based on one or more input values.

8. The method of claim 1, wherein review by the user comprises accepting the custom bundle or declining the custom bundle.

9. The method of claim 8, wherein the method restarts in the event the user declines the custom bundle.

10. The method of claim 8, wherein the method further comprises processing the custom bundle in the event the user accepts the custom bundle.

11. A computer readable media comprising code to perform the acts of the method of claim 1.

12. A system, comprising:
an item presentation module that displays a plurality of items; and
a bundling module that receives a plurality of user selections based on the plurality of items and forms a custom bundle based on the plurality of user selections.

13. The system of claim 12, wherein the bundling module further calculates one or more discounts based on the custom bundle.

14. The system of claim 13, wherein the bundling module further calculates terms and conditions associated for each of the one or more discounts.

15. The system of claim 13, wherein the bundling module further calculates a profit margin for each of the one or more discounts.

16. The system of claim 13, wherein the bundling module further displays the custom bundle and the one or more calculated discounts via a bundle presentation module for review by the user.

17. The system of claim 12, wherein the system further comprises at least one database for storing information related to the plurality of items comprising at least two from a group of products, services, and popular custom bundles.

18. The system of claim 12, wherein the plurality of user selections is based on one or more input values.

19. The system of claim 12, wherein review by the user comprises accepting the custom bundle or declining the custom bundle.

20. The system of claim 12, wherein the system further comprises one or more adapters for processing the custom bundle.

21. A method, comprising:
receiving one or more user selections to form a custom bundle;
calculating one or more discounts based on the custom bundle; and
processing the custom bundle based on an acceptance by the user.

22. The method of claim 21, wherein calculating the one or more discounts further comprises calculating terms and conditions associated for each of the one or more discounts.

23. The method of claim 21, wherein calculating the one or more discounts further comprises calculating a profit margin for each of the one or more discounts.

24. The method of claim 21, wherein the method further comprises displaying the custom bundle and the one or more calculated discounts for review by the user.

25. A computer readable media comprising code to perform the acts of the method of claim 21.
